(19) United States
(12) Patent Application Publication
(10) Pub. No.: US 2026/0123568 A1
(43) Pub. Date: May 7, 2026

(54) DOWNFORCE MONITORING SYSTEM FOR AN AGRICULTURAL ROW UNIT

(71) Applicant: CNH Industrial Canada, Ltd., Saskatoon (CA)

(72) Inventor: Trevor Lawrence Kowalchuk, Saskatoon (CA)

(21) Appl. No.: 18/939,335

(22) Filed: Nov. 6, 2024

(51) Int. Cl. A01C 7/20; A01C 5/06

(52) U.S. Cl. CPC A01C 7/203; A01C 5/064

(57) ABSTRACT

A downforce monitoring system for an agricultural row unit includes a controller having a processor and a memory. The controller is configured to receive one or more signals from one or more sensors. Each of the one or more signals is indicative of a downforce applied to a soil surface by a gauge wheel of the agricultural row unit. The controller is also configured to determine a determined downforce applied to the soil surface by the gauge wheel based on the one or more signals. The one or more sensors are engaged with a pin, and the pin is configured to rotatably couple a depth adjustment arm to a shaft of the row unit.

### BACKGROUND

The present disclosure relates generally to a downforce monitoring system for an agricultural row unit.

Generally, seeding implements (e.g., seeders) are towed behind a tractor or other work vehicle. Seeding implements typically include multiple row units distributed across a width of the implement. Each row unit is configured to deposit seeds at a target depth beneath the soil surface of a field, thereby establishing rows of planted seeds. For example, each row unit typically includes a ground engaging tool or opener that forms a trench for seed deposition into the soil. A seed tube (e.g., positioned adjacent to the opener) is configured to deposit seeds into the trench. The opener/seed tube may be followed by a packer wheel that packs the soil on top of the deposited seeds.

Certain row units include a gauge wheel configured to control a penetration depth of the opener (e.g., opener disc) into the soil. For example, the row unit may include a depth adjustment handle configured to adjust a vertical position of the gauge wheel relative to a frame of the row unit. Because the opener is non-movably coupled to the frame and the gauge wheel is configured to contact the surface of the soil during operation of the row unit, controlling the vertical position of the gauge wheel adjusts the penetration depth of the opener into the soil. The downforce applied by the gauge wheel to the soil surface may be adjusted based on soil conditions, soil type, and/or seed type, among other factors. Accordingly, the seeding implement may include a downforce actuator configured to adjust the downforce applied by the gauge wheel to the soil surface. In certain seeding implements, the downforce actuator is manually controlled. Unfortunately, manually controlling the downforce actuator may cause the gauge wheel to apply a downforce to the soil surface that is higher or lower than a desired downforce (e.g., due to changing soil conditions throughout the field). If the downforce is higher than desired, the soil may be undesirably compacted. In addition, if the downforce is lower than desired, the gauge wheel may not contact the soil surface, thereby undesirably reducing the penetration depth of the opener (e.g., opener disc).

### BRIEF DESCRIPTION

In certain embodiments, a downforce monitoring system for an agricultural row unit includes a controller having a processor and a memory. The controller is configured to receive one or more signals from one or more sensors. Each of the one or more signals is indicative of a downforce applied to a soil surface by a gauge wheel of the agricultural row unit. The controller is also configured to determine a determined downforce applied to the soil surface by the gauge wheel based on the one or more signals. The one or more sensors are engaged with a pin, and the pin is configured to rotatably couple a depth adjustment arm to a shaft of the row unit.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units;

FIG. 2 is a perspective view of a first side of an embodiment of a row unit that may be employed within the agricultural implement of FIG. 1;

FIG. 3 is a perspective view of a second side of the row unit of FIG. 2;

FIG. 4 is a detailed cross-sectional side view of the row unit of FIG. 2, taken within line 2-2 of FIG. 2, showing one or more sensors of a downforce monitoring system for determining a downforce;

FIG. 5 is a cross-sectional side view of another embodiment of the row unit of FIG. 2, showing the one or more sensors; and

FIG. 6 is a schematic view of an embodiment of the downforce monitoring system that may be utilized with the row unit of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As discussed in detail below, the agricultural implement may include a downforce monitoring system configured to monitor and/or control the downforce applied by the gauge wheel of at least one row unit. In certain embodiments, the downforce monitoring system includes a controller configured to receive a signal from one or more sensors, the signal indicative of a downforce applied to a soil surface by a gauge wheel of an agricultural row unit. The one or more sensors are engaged with a pin that rotatably couples a depth adjustment arm to a shaft of the row unit. The controller is also configured to output a first output signal (e.g., to a user interface, to another controller, etc.) indicative of the determined downforce and/or to output a second output signal to the downforce actuator to control the downforce applied to the soil surface by the gauge wheel based on the determined downforce and a target downforce.

The one or more sensors may be disposed along the pin such that the one or more sensors contact the shaft, an arm portion of the depth adjustment arm, or a combination thereof. In certain embodiments, one or more sensors may be disposed within an interior of the pin. The one or more sensors may detect a downforce applied by the shaft to the pin, a bending moment applied to the pin by the depth adjustment arm and/or the shaft, or a combination thereof. In certain embodiments, a sensor fusion technique, a statistical technique, a filter, or the like may be used to combine one or more signals received from the one or more sensors.

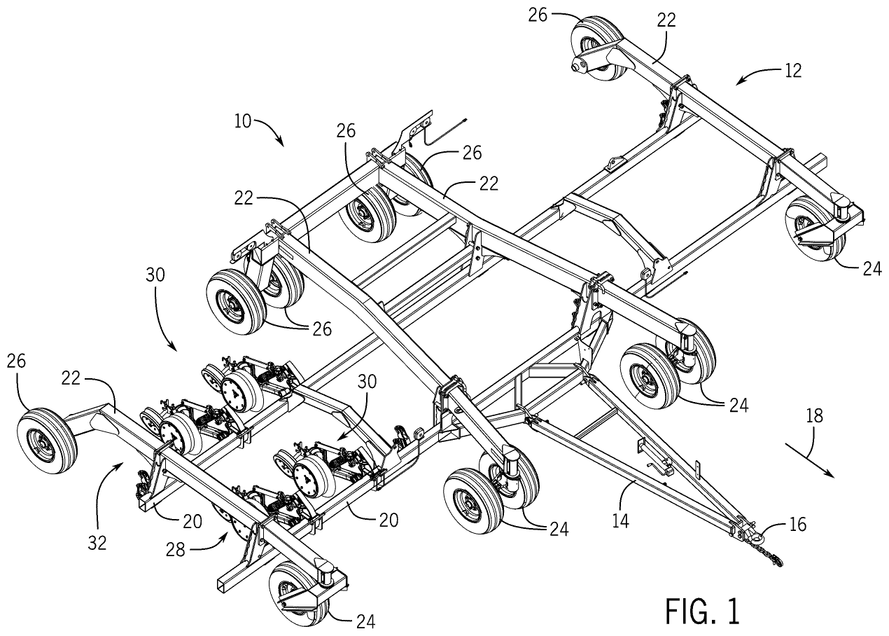

FIG. 1 is a perspective view of an embodiment of an agricultural implement 10 having multiple row units. As illustrated, the agricultural implement 10 includes a frame 12 and a tow bar 14 coupled to the frame 12. In the illustrated embodiment, the tow bar 14 is pivotally coupled to the frame 12 and includes a hitch 16. The hitch 16 is configured to interface with a corresponding hitch of a work vehicle (e.g., tractor, etc.), thereby enabling the work vehicle to tow the agricultural implement 10 through a field along a direction of travel 18. While the illustrated tow bar 14 forms an A-frame, in certain embodiments, the tow bar may have any other suitable configuration (e.g., a single bar extending along the direction of travel, etc.). In addition, while the tow bar 14 is pivotally coupled to the frame 12 in the illustrated embodiment, in certain embodiments, the tow bar may be rigidly coupled to the frame. Furthermore, in certain embodiments, the hitch 16 may be coupled to a corresponding hitch of another implement (e.g., an air cart, etc.), and the other implement may be coupled to the work vehicle (e.g., via respective hitches). While the agricultural implement 10 is configured to be towed through the field by a work vehicle in the illustrated embodiment, in certain embodiments, the agricultural implement may be part of a self-propelled vehicle (e.g., in which the frame of the agricultural implement is coupled to a main frame/chassis of the self-propelled vehicle).

In the illustrated embodiment, the frame 12 of the agricultural implement 10 includes two toolbars 20 and four supports 22. As illustrated, wheels are coupled to the supports 22, and the supports 22 are coupled to the toolbars 20 (e.g., via fasteners, via a welded connection, etc.). In the illustrated embodiment, front wheel(s) 24 are rotatably coupled to a respective front portion of each support 22, and rear wheel(s) 26 are rotatably coupled to a respective rear portion of each support 22. The front portion of each support 22 is positioned forward of the respective rear portion relative to the direction of travel 18. The wheels maintain the supports 22 above the surface of the field and enable the agricultural implement 10 to move along the direction of travel 18. In the illustrated embodiment, pivotal connections between the front wheels 24 and the respective supports 22 enable the front wheels 24 to caster, thereby enhancing the turning ability of the agricultural implement 10 (e.g., at a headland, during transport, etc.). However, in certain embodiments, at least one front wheel may be non-pivotally coupled to the respective support, and/or at least one rear wheel may be pivotally coupled to the respective support. While the frame 12 of the agricultural implement 10 has four supports 22 in the illustrated embodiment, in certain embodiments, the agricultural implement may have more or fewer supports (e.g., 0, 1, 2, 3, 4, 5, 6, or more). Furthermore, in certain embodiments, the toolbars 20 of the frame 12 may be supported by other and/or additional suitable structures (e.g., connectors extending between toolbars, wheel mounts coupled to toolbars, etc.).

In the illustrated embodiment, a first row 28 of row units 30 is coupled to the front toolbar 20, and a second row 32 of row units 30 is coupled to the rear toolbar 20. While the agricultural implement 10 has two toolbars 20 and two corresponding rows of row units 30 in the illustrated embodiment, in other embodiments, the agricultural implement may include more or fewer toolbars (e.g., 1, 2, 3, 4, 5, 6, or more) and a corresponding number of rows of row units. Furthermore, while the agricultural implement 10 includes one type of row unit in the illustrated embodiment, in other embodiments, the agricultural implement may include multiple types of row units and/or other suitable agricultural tools (e.g., spray nozzle(s), finishing reel(s), tillage shank(s), etc.).

In the illustrated embodiment, each row unit 30 of the agricultural implement 10 is configured to deposit agricultural product (e.g., seed, fertilizer, etc.) into the soil. For example, certain row units 30 (e.g., all of the row units 30 of the agricultural implement 10, a portion of the row units 30 of the agricultural implement 10, at least one row unit 30 of the agricultural implement 10, etc.) include an opener (e.g., opener disc) configured to form a trench within the soil for agricultural product deposition into the soil. The row unit 30 also includes a gauge wheel (e.g., positioned adjacent to the opener) configured to control a penetration depth of the opener into the soil. For example, the opener may be non-movably coupled to a frame of the row unit, and the gauge wheel may be movably coupled to the frame and configured to contact a surface of the soil during operation of the row unit. Accordingly, adjusting the vertical position of the gauge wheel relative to the frame of the row unit controls the penetration depth of the opener into the soil. In addition, the row unit includes a product tube (e.g., seed tube) configured to deposit the agricultural product into the trench formed by the opener. In certain embodiments, the opener/agricultural product tube may be followed by a packer assembly (e.g., including a packer wheel, etc.) that packs soil on top of the deposited agricultural product. In certain embodiments, each row unit 30 of the second row 32 is laterally offset (e.g., offset in a direction perpendicular to the direction of travel 18) from a respective row unit 30 of the first row 28, such that two adjacent rows of agricultural product are established within the soil. While the illustrated agricultural implement 10 includes two row units 30 in the first row 28 and two row units 30 in the second row 32 for illustrative purposes, the agricultural implement may have any suitable number of row units in the first row and any suitable number of row units in the second row. For example, the agricultural implement may include 5, 10, 15, 20, 25, or 30 row units in the first row and a corresponding number of row units in the second row. Furthermore, in certain embodiments, the second row may include more or fewer row units than the first row.

In certain embodiments, the agricultural implement and/or at least one row unit of the agricultural implement includes a downforce actuator configured to control a downforce applied by the gauge wheel to the soil surface. For example, in certain embodiments, the agricultural implement may include multiple downforce actuators each configured to control the downforce applied by the gauge wheels of a group of row units coupled to the downforce actuator. The downforce actuator may enable the downforce applied by the gauge wheel to the soil surface to be adjusted based on soil conditions, soil type, agricultural product type (e.g., seed type, fertilizer type, etc.), other suitable parameters, or a combination thereof. For example, the downforce may be reduced for moist soil conditions to reduce compaction, and the downforce may be increased for harder soil to enable the gauge wheel to maintain contact with the soil surface.

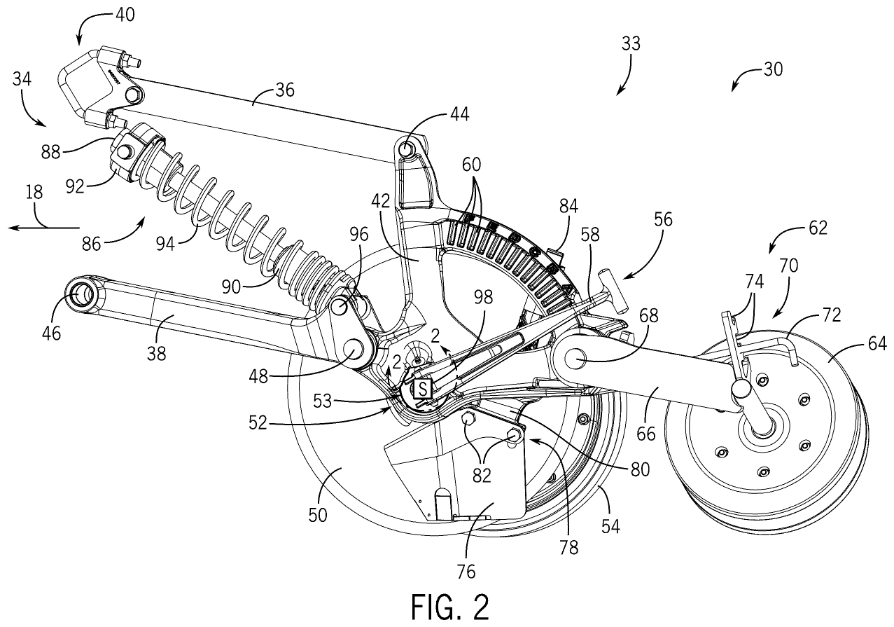

FIG. 2 is a perspective view of a first side 33 of an embodiment of a row unit 30 (e.g., agricultural row unit) that may be employed within the agricultural implement of FIG. 1. In the illustrated embodiment, the row unit 30 includes a linkage assembly 34 configured to couple the row unit 30 to a respective toolbar of the agricultural implement. The linkage assembly 34 includes an upper link 36 and a lower link 38. A mount 40 is positioned at a first end of the upper link 36 and is configured to couple to the respective toolbar of the agricultural implement. In addition, a second end of the upper link 36 is coupled to a frame 42 of the row unit 30 by a fastener 44. The lower link 38 includes an opening 46 configured to receive a fastener that rotatably couples the lower link 38 to the respective toolbar. In addition, a second end of the lower link 38 is rotatably coupled to the frame 42 of the row unit by a fastener 48. The linkage assembly 34 enables the frame 42 of the row unit 30 to move vertically (e.g., raise and lower) relative to the respective toolbar (e.g., in response to obstructions or variations in the terrain, for raising the row unit frame for transport, etc.). While the linkage assembly 34 includes the upper link 36 and the lower link 38 in the illustrated embodiment, in other embodiments, the row unit may include any other suitable linkage configuration to facilitate vertical movement of the row unit frame relative to the respective toolbar.

In the illustrated embodiment, the row unit 30 includes an opener disc 50 rotatably and non-movably coupled to the frame 42 by a bearing assembly 52. The bearing assembly 52 enables the opener disc 50 to freely rotate as the opener disc engages the soil, thereby enabling the opener disc 50 to excavate a trench within the soil. While the row unit 30 includes an opener disc 50 in the illustrated embodiment, in other embodiments, the row unit may include another suitable opener (e.g., shank, point, etc.) configured to excavate a trench within the soil. As discussed in further detail herein, the bearing assembly 52 includes a shaft 53 about which the opener disc 50 rotates.

In the illustrated embodiment, the row unit 30 includes a gauge wheel 54 configured to control a penetration depth of the opener disc 50 into the soil. The gauge wheel 54 is configured to rotate along the surface of the soil. Accordingly, adjusting the vertical position of the gauge wheel 54 relative to the frame 42 controls the penetration depth of the opener disc 50 into the soil. As discussed in detail below, the gauge wheel 54 is rotatably coupled to a gauge wheel support arm, and the gauge wheel support arm is pivotally coupled to the frame 42. Accordingly, pivoting of the gauge wheel support arm drives the gauge wheel 54 to move vertically relative to the frame 42. In certain embodiments, the gauge wheel 54 is positioned against the opener disc 50 to remove soil from a side of the opener disc 50 during operation of the row unit 30.

The row unit 30 includes a depth adjustment assembly 56 configured to control the vertical position of the gauge wheel 54, thereby controlling the penetration depth of the opener disc 50 into the soil. In the illustrated embodiment, the depth adjustment assembly 56 includes a depth adjustment handle 58 and depth gauge notches 60. The depth adjustment handle 58 is non-rotatably coupled to the gauge wheel support arm and configured to drive the gauge wheel support arm to pivot about a pivot point, thereby controlling the vertical position of the gauge wheel 54 relative to the frame 42/opener disc 50. The depth adjustment handle 58 may be moved to any of the depth gauge notches 60 to adjust the vertical position of the gauge wheel 54. The depth gauge notches 60 block rotation of the depth adjustment handle 58, thereby maintaining the vertical position of the gauge wheel 54 (e.g., substantially fixing the position of the gauge wheel 54 relative to the frame 42). To adjust the vertical position of the gauge wheel 54/penetration depth of the opener disc 50, the depth adjustment handle 58 may be moved away from the depth gauge notches 60, thereby facilitating rotation of the depth adjustment handle 58 along the depth gauge notches 60. Upon release of the depth adjustment handle 58, a biasing member may urge the depth adjustment handle 58 to engage the depth gauge notches 60, thereby blocking rotation of the depth gauge handle 58 among the depth gauge notches 60. While the vertical position of the gauge wheel/penetration depth of the opener disc is controlled by the depth adjustment handle in the illustrated embodiment, in other embodiments, another suitable device, such as an actuator, may be used to control the vertical position of the gauge wheel/penetration depth of the opener disc.

In the illustrated embodiment, the row unit 30 includes a packer wheel assembly 62 having a packer wheel 64 and a support arm 66. The support arm 66 is pivotally coupled to the frame 42 by a fastener 68, and the packer wheel 64 is rotatably coupled to the support arm 66. The packer wheel 64 is configured to pack soil on top of the deposited agricultural product (e.g., to facilitate development of the resulting agricultural crop). The force applied by the packer wheel 64 to the soil surface may be adjusted via an adjustment assembly 70. The adjustment assembly 70 includes a torsion spring 72 configured to urge the support arm 66/packer wheel 64 toward the soil surface. An end of the torsion spring 72 may be moved between notches 74 to control the force applied by the packer wheel 64 to the soil surface. While the row unit includes the packer wheel assembly 62 in the illustrated embodiment, in other embodiments, the packer wheel assembly may be omitted.

In the illustrated embodiment, the row unit 30 includes a scraper 76 disposed adjacent to the opener disc 50 and configured to remove accumulated soil from the opener disc 50. As illustrated, a mounting portion 78 of the scraper 76 is rigidly coupled to a mounting bracket 80 by fasteners 82. In alternative embodiments, the scraper may be coupled directly to the frame, or the scraper may be mounted to another suitable mounting structure. In the illustrated embodiment, the mounting bracket 80 is pivotally coupled to the frame 42 by a shaft, and a biasing member urges the bracket 80/scraper 76 toward the opener disc 50, thereby facilitating debris removal. While the illustrated row unit includes a scraper, in other embodiments, the scraper may be omitted. Furthermore, the row unit 30 includes an agricultural product tube 84 (e.g., seed tube) configured to direct agricultural product into the trench formed by the opener disc 50.

The row unit 30 includes a spring assembly 86 configured to facilitate upward vertical movement of the row unit frame 42 (e.g., in response to contact between the opener disc 50 and an obstruction within the field). In the illustrated embodiment, the spring assembly 86 includes a bolt/tube assembly 88 that connects a lower trunnion 90 to an upper trunnion 92. The bolt/tube assembly 88 and lower trunnion 90 are surrounded by a compression spring 94. In addition, the spring assembly 86 is rotatably coupled to the lower link 38 by a fastener 96 to enable the spring assembly 86 to rotate relative to the lower link 38. In certain embodiments, a downforce actuator is configured to compress the spring assemblies of a group of row units. The force applied by the downforce actuator may be controlled to control the downforce applied by the gauge wheel 54 to the soil surface (e.g., while compressing the spring 94). In addition, the spring 94 is configured to compress to facilitate upward vertical movement of the frame 42 in response to the opener disc 50 or the gauge wheel 54 encountering an obstruction (e.g., rock, branch, etc.) within the field. While the row unit includes the spring assembly in the illustrated embodiment, in other embodiments, the spring assembly may be omitted. For example, in certain embodiments, the spring assembly may be omitted, and a downforce actuator may extend from the toolbar to the row unit (e.g., to the frame of the row unit, to a link of the linkage assembly, etc.).

As discussed in detail below, the agricultural implement may include a downforce monitoring system configured to monitor and/or control the downforce applied by the gauge wheel of the row unit. In certain embodiments, the downforce monitoring system includes a controller configured to receive one or more signals from one or more sensors, the signal indicative of a downforce applied to a soil surface by a gauge wheel of an agricultural row unit. The one or more sensors are engaged with a pin that rotatably couples a depth adjustment arm to a shaft of the row unit. The controller is also configured to output a first output signal (e.g., to a user interface, to another controller, etc.) indicative of the determined downforce and/or to output a second output signal to the downforce actuator to control the downforce applied to the soil surface by the gauge wheel based on the determined downforce and a target downforce.

In the illustrated embodiment, the downforce monitoring system includes one or more sensors 98 communicatively coupled to the controller. As discussed herein, the one or more sensors 98 are at least partially coupled to (e.g., engaged with) a pin that rotatably couples the depth adjustment handle 58 to the shaft 53. The depth adjustment handle 58 is non-rotatably coupled to the gauge wheel support arm via the shaft 53 and configured to drive the gauge wheel support arm to rotate about the pivot point, thereby controlling the vertical position of the gauge wheel 54 relative to the frame 42/opener disc 50. In addition, the downforce applied by the gauge wheel 54 to the soil surface urges the gauge wheel support arm to rotate about the pivot point. Due to the non-rotatable coupling between the gauge wheel support arm and the depth adjustment handle 58, the downforce urges the depth adjustment handle 58 to rotate. However, as previously discussed, rotation of the depth adjustment handle 58 is blocked by the depth gauge notches 60 (e.g., while the depth adjustment handle 58 is engaged with the depth gauge notches 60). Because rotation of the depth adjustment handle 58 is blocked, a bending load is applied to the pin coupling the depth adjustment handle 58 to the shaft 53. The one or more sensors 98 monitor the bending load on the pin and provide the controller with one or more signals indicative of the bending load. The bending load is indicative of a downforce on the gauge wheel 54. Accordingly, the controller is configured to determine the downforce on the gauge wheel 54 based on feedback from the one or more sensors 98.

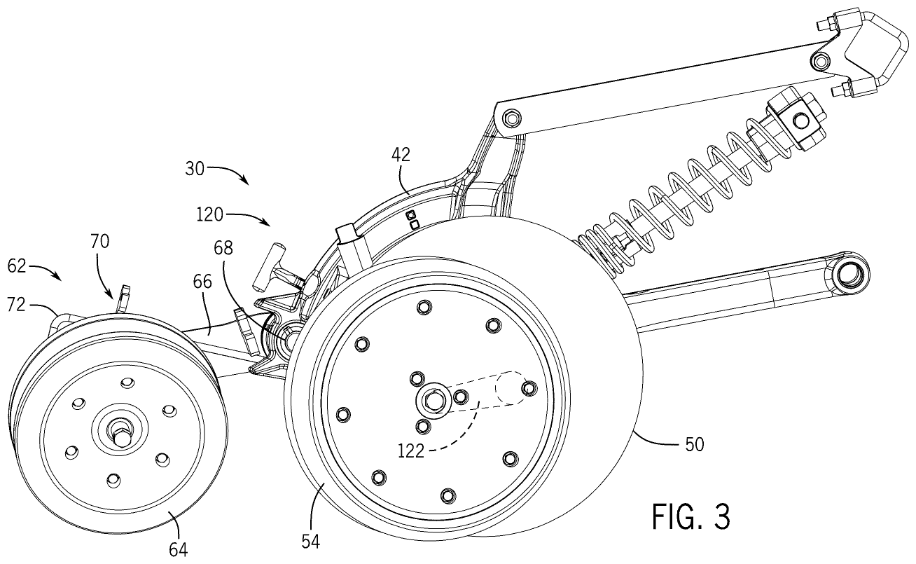

FIG. 3 is a perspective view of a second side 120 of the row unit 30 of FIG. 2. In the illustrated embodiment, the row unit 30 includes the gauge wheel 54, which is configured to control a penetration depth of the opener disc 50 into the soil. The gauge wheel 54 is configured to rotate along the surface of the soil. Accordingly, adjusting the vertical position of the gauge wheel 54 relative to the frame 42 controls the penetration depth of the opener disc 50 into the soil. The gauge wheel 54 is rotatably coupled to a gauge wheel support arm 122, and the gauge wheel support arm 122 is pivotally coupled to the frame 42. Accordingly, pivoting of the gauge wheel support arm 122 drives the gauge wheel 54 to move vertically relative to the frame 42. In the illustrated embodiment, the gauge wheel 54 is positioned against the opener disc 50 to remove soil from a side of the opener disc 50 during operation of the row unit 30. However, in certain embodiments, the gauge wheel 54 may be separated from the opener disc 50 by a gap.

As previously discussed, the row unit 30 includes the packer wheel assembly 62 having the packer wheel 64 and the support arm 66. The support arm 66 is pivotally coupled to the frame 42 by the fastener 68, and the packer wheel 64 is rotatably coupled to the support arm 66. The packer wheel 64 is configured to pack soil on top of the deposited agricultural product (e.g., to facilitate development of the resulting agricultural crop). The force applied by the packer wheel 64 to the soil surface may be adjusted via the adjustment assembly 70. The adjustment assembly 70 includes the torsion spring 72 configured to urge the support arm 66/packer wheel 64 toward the soil surface. While the row unit 30 includes the packer wheel assembly 62 in the illustrated embodiment, in other embodiments, the packer wheel assembly may be omitted.

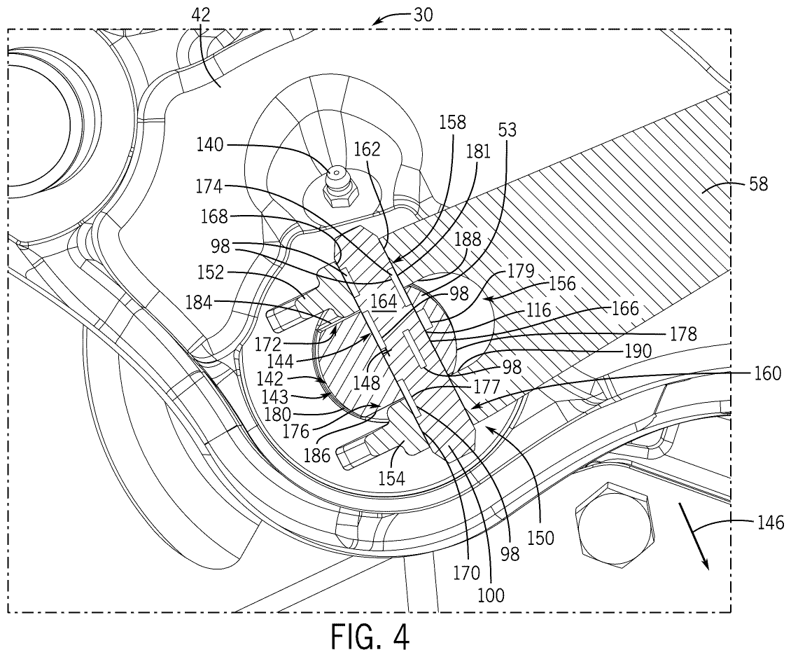

FIG. 4 is a detailed cross-sectional side view of the row unit 30 of FIG. 2, taken within line 2-2 of FIG. 2, showing the one or more sensors 98 of a downforce monitoring system for determining a downforce. As discussed herein, the one or more sensors 98 are communicatively coupled to the controller, and configured to output one or more signals to the controller. In certain embodiments, the one or more signals may be indicative of a downforce applied to the soil by the gauge wheel.

In the illustrated embodiment, the shaft 53 is rotatably coupled to the frame 42 of the row unit 30. As shown, the frame 42 includes a lubrication port 140 formed into the frame 42. The lubrication port 140 is fluidly coupled to a bore 142 formed into the frame 42 and configured to receive the bearing assembly 52, which includes the shaft 53. In certain embodiments, the lubrication port 140 is configured to receive a lubrication fluid (e.g., lubrication oil) and to provide the lubrication fluid to the bore 142 to provide lubrication to the bearing assembly 52.

In the illustrated embodiment, the shaft 53 includes an axial end portion 143. The axial end portion 143 of the shaft 53 includes a first hole 144 (e.g., first through hole) that extends through (e.g., is formed into) the shaft 53 in a radial direction 146 relative to a central axis 148 of the shaft 53. As shown, the depth adjustment handle 58 includes arms 150 (e.g., first arm 152, second arm 154) separated by a notch 156 (e.g., gap). The first arm 152 includes a second hole 158 (e.g., second through hole) that extends through (e.g., is formed into) the first arm 152. Additionally, the second arm 154 includes a third hole 160 (e.g., third through hole) that extends through (e.g., is formed into) the second arm 154. As shown, the first hole 144, the second hole 158, and the third hole 160 are configured to concurrently receive the pin 100, such that the pin 100 rotatably couples the depth adjustment handle 58 to the shaft 53.

In the illustrated embodiment, one or more sensors 98 are at least partially coupled to (e.g., engaged with, disposed on) an outer surface 162 of the pin 100. In certain embodiments, one or more sensors 98 may be disposed within an interior 164 of the pin 100, such that the one or more sensors 98 are at least partially coupled to (e.g., engaged with) the pin 100. In certain embodiments, one or more sensors 98 may be at least partially coupled to a first inner surface 166 of the first hole 144, a second inner surface 168 of the second hole 158, a third inner surface 170 of the third hole 160, or a combination thereof.

In certain embodiments, one or more sensors 98 may be disposed across (e.g., span across, traverse over, etc.) a first interface 172 between the first inner surface 166 and the second inner surface 168. For example, a sensor 174 of the one or more sensors 98 may be concurrently coupled to (e.g. in contact with) the first inner surface 166 and the second inner surface 168. In certain embodiments, one or more sensors 98 may be disposed across (e.g., span across, traverse over, etc.) a second interface 176 between the first inner surface 166 and the third inner surface 170. For example, a sensor 177 of the one or more sensors 98 may be concurrently coupled to (e.g., in contact with) the first inner surface 166 and the third inner surface 170.

In certain embodiments, the one or more sensors 98 may include force sensor(s) (e.g., load cell(s)), strain gauge(s), other suitable sensor type(s), or a combination thereof. For example, a force sensor 179 may be disposed between the pin 100 and an upper portion 178 of the shaft 53, and the sensor may output a sensor signal indicative of a downward force exerted by the upper portion 178 of the shaft 53 onto the pin 100. The downward force exerted by the upper portion 178 of the shaft 53 onto the pin 100 may be used by the controller to determine a downforce exerted by the gauge wheel on to the ground. Additionally or alternatively, a strain gage 181 may be disposed on the pin 100 (e.g., near the first interface 172 and/or the second interface 176, and the sensor may output a sensor signal indicative of strain induced on the pin 100 from the first arm 152 and/or the second arm 154 and the shaft 53. The strain gage 181 may measure a bending load exerted onto the pin 100 by the first arm 152 (e.g., and/or the second arm 152) of the depth adjustment arm 58 onto the pin 100. The controller may determine an estimated bending load based on the signal received from the strain gage 181. The estimated bending load may be used to determine an estimated downforce exerted by the gage wheel onto the soil. In certain embodiments, the controller may use a sensor fusion technique, a statistical technique, or the like to estimate the downforce exerted by the gauge wheel based on a combination of signals received from the force sensor 179, the strain gage 181, and/or other sensor(s) 98.

In the illustrated embodiment, the axial end portion 143 of the shaft 53 is disposed between the first arm 152 and the second arm 154 of the depth adjustment handle 58. As shown, an outer surface 180 (e.g., outer circumferential surface, outer perimeter) of the axial end portion 143 that extends along the central axis 148 of the shaft 53 includes flat sides 182 (e.g., first flat side 184, second flat side 186). As shown, the first flat side 184 abuts a first inner surface 188 of the first arm 152, and the second flat side 186 abuts a second inner surface 190 of the second arm 154. Accordingly, contact between the flat sides 182 of the axial end portion 143 and the inner surfaces of the arms, in combination with the contact between the pin 100 and the shaft 53, blocks rotation of the depth adjustment handle 58 relative to the shaft 53 about the central axis 148, thereby enabling the depth adjustment handle 58 to drive the shaft to rotate. Although the axial end portion 143 of the shaft 53 has two flat sides 182, the axial end portion 143 may have one or more flat sides 182. In certain embodiments, the shaft 53 may be another shape that non-rotatably couples the depth adjustment handle 58 with the shaft 53 in combination with the pin 100.

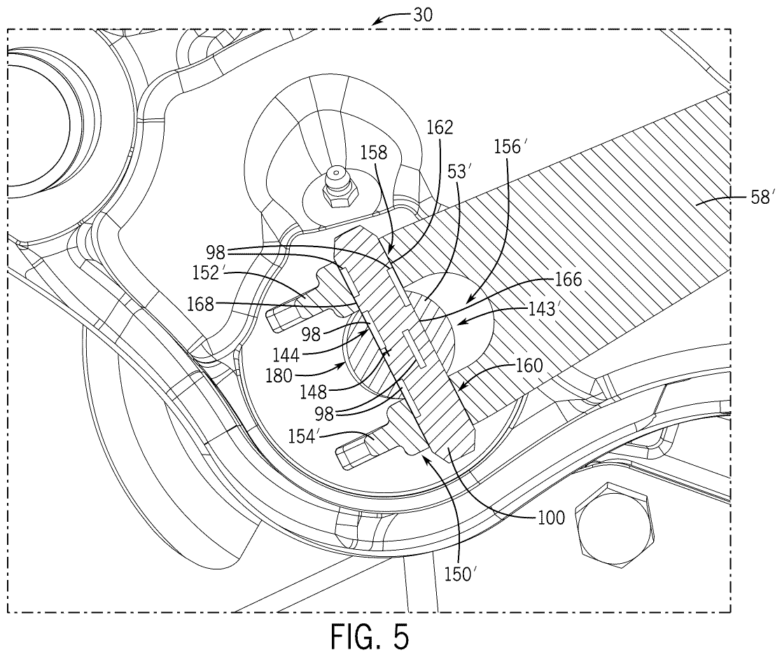

FIG. 5 is a cross-sectional side view of an additional embodiment of the row unit 30 of FIG. 2 taken within line 2-2, further illustrating the one or more sensors 98. In the illustrated embodiment, the shaft 53′ includes the axial end portion 143′. The axial end portion 143′ of the shaft 53′ includes the first hole 144 (e.g., first through hole) that extends through (e.g., is formed into) the shaft 53′ in the radial direction 146 relative to the central axis 148 of the shaft 53′. As shown, the depth adjustment handle 58′ includes arms 150′ (e.g., first arm 152′, second arm 154′) separated by the notch 156′ (e.g., gap). The first arm 152′ includes the second hole 158 (e.g., second through hole) that extends through (e.g., is formed into) the first arm 152′. Additionally, the second arm 154′ includes the third hole 160 (e.g., third through hole) that extends through (e.g., is formed into) the second arm 154′. As shown, the first hole 144, the second hole 158, and the third hole 160 are configured to concurrently receive the pin 100, such that the pin 100 rotatably couples the depth adjustment handle 58 to the shaft 53.

In the illustrated embodiment, the axial end portion 143′ of the shaft 53′ is disposed between the first arm 152′ and the second arm 154′ of the depth adjustment handle 58′. As shown, the outer surface 180′ (e.g., outer circumferential surface, outer perimeter) of the axial end portion 143′ is rounded (e.g., round in shape). As shown, the outer surface does not include flat sides. In the illustrated embodiment, the outer surface 180′ of the axial end portion 143′ is circular in shape. In certain embodiments, the outer surface 180′ of the end portion 143′ may be elliptical in shape. Contact between the outer surface 162 of the pin 100 and the first inner surface 166 of the shaft 53 in combination with the second inner surface 168 of the arms 150′ blocks rotation of the depth adjustment handle 58′ relative to the shaft 53′ about the axis 148.

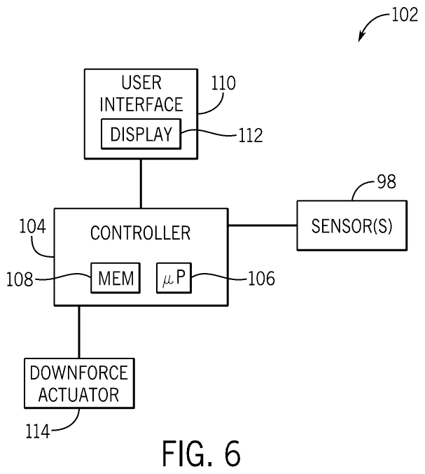

FIG. 6 is a schematic view of an embodiment of a downforce monitoring system 102 that may be utilized with the row unit of FIG. 2. In the illustrated embodiment, the downforce monitoring system 102 includes a controller 104 communicatively coupled to the one or more sensors 98. In certain embodiments, the controller 104 is an electronic controller having electrical circuitry configured to receive respective signals from the one or more sensors 98. In the illustrated embodiment, the controller 104 includes a processor 106, such as the illustrated microprocessor, and a memory device 108. The controller 104 may also include one or more storage devices and/or other suitable components. The processor 106 may be used to execute software, such as software for determining a determined downforce applied to the soil surface by the gauge wheel, and so forth. Moreover, the processor 106 may include multiple microprocessors, one or more “general-purpose” microprocessors, one or more special-purpose microprocessors, and/or one or more application specific integrated circuits (ASICS), or some combination thereof. For example, the processor 106 may include one or more reduced instruction set (RISC) processors.

The memory device 108 may include a volatile memory, such as random access memory (RAM), and/or a nonvolatile memory, such as read-only memory (ROM). The memory device 108 may store a variety of information and may be used for various purposes. For example, the memory device 108 may store processor-executable instructions (e.g., firmware or software) for the processor 106 to execute, such as instructions for determining the determined downforce, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for determining the determined downforce, etc.), and any other suitable data.

In the illustrated embodiment, the one or more sensors 98 are communicatively coupled to the controller 104. As previously discussed, the one or more sensors 98 are configured to output one or more signals to the controller 104. The one or more signals (e.g., sensor signal(s)) are indicative of the downforce applied to the soil surface by the gauge wheel of the agricultural row unit.

The controller 104 is configured to receive the one or more signals (e.g., sensor signal(s)) from the one or more sensors 98. The controller 104 is also configured to determine a determined downforce applied to the soil surface by the gauge wheel based on the one or more signals received from the one or more sensors 98. For example, in certain embodiments, the controller is configured to receive a signal indicative of a strain (e.g., of the pin), a signal indicative of a force (e.g., exerted on the pin by the shaft), or a combination thereof, and the controller is configured to determine the determined downforce based on the strain, the force, or a combination thereof. In certain embodiments, the controller may determine an estimated force exerted onto the pin by the shaft based on a force exerted onto the pin by the first arm of the depth adjustment handle, the second arm of the depth adjustment handle, or a combination thereof.

In response to determining the determined downforce, the controller 104 may output a first output signal to a user interface 110 of the downforce monitoring system 102 indicative of the determined downforce. In the illustrated embodiment, the user interface 110 is communicatively coupled to the controller 104 and includes a display 112. Upon receipt of the first output signal from the controller 104, the user interface 110 may present a graphic and/or numerical representation of the determined downforce on the display 112. Accordingly, an operator may identify the downforce by viewing the display 112.

In addition, in response to determining the downforce, the controller 104 may output a second output signal to a downforce actuator 114 of the downforce monitoring system 102 to control a downforce applied to the soil surface by the gauge wheel. In the illustrated embodiment, the downforce actuator 114 is communicatively coupled to the controller 104 and configured to control the downforce applied to the soil surface by the gauge wheel. For example, in certain embodiments, the downforce actuator may extend from the toolbar of the agricultural implement to the frame/link of the row unit. In further embodiments, the downforce actuator may extend from the toolbar to a transverse member coupled to multiple row units (e.g., the spring assemblies of multiple row units). The controller 104 may control the downforce actuator 114 to bias the opener towards the ground. In certain embodiments, the downforce applied by the downforce actuator 114 may be counteracted by reaction forces from soil resistance through the opener disc and/or through the soil contacting the gauge wheel. It may be recognized that an absence of a reaction force on the gauge wheel may indicate that the opener is likely not fully in the ground due to the downforce of the opener not being large enough to counteract the reaction force of the ground to the opener disc. Conversely, if the reaction force on the gauge wheel from the ground is too large, then wear on the components of the opener (e.g., bearings, pins, gauge wheel, etc.) may be accelerated. Additionally or alternatively, a reaction force that is too large may create a high soil compaction zone under the gauge wheel, which prevents the opener from closing the seed trench properly and creates voids between the seed to soil contact. This prevents nutrient uptake into the seed that affects germination and yield. Furthermore, the compacted soil may make plant and root development less optimal which also negatively affects yield.

The downforce actuator may include a hydraulic actuator, a pneumatic actuator, an electromechanical actuator, another suitable type of actuator, or a combination thereof. In certain embodiments, the downforce actuator includes a fluid actuator (e.g., hydraulic actuator, pneumatic actuator, etc.) controlled by a fluid flow. In such embodiments, the downforce monitoring system includes a valve assembly communicatively coupled to the controller and configured to control the fluid flow to the fluid actuator. Accordingly, the fluid actuator is fluidly coupled to the controller via the valve assembly. The downforce actuator is configured to urge the gauge wheel of the row unit against the soil surface.

In certain embodiments, the controller 104 is configured to output the second output signal to the downforce actuator 114 to control the downforce based on the determined downforce and a target downforce. The target downforce may be stored within the controller 104 (e.g., within the storage device), determined by the controller 104 (e.g., based on a soil condition map of the field, a yield map of the field, a soil type map of the field, agricultural product type, agricultural product flow rate, other suitable parameter(s), or a combination thereof), or manually input via the user interface 110 (e.g., via a touch screen interface of the display 112). In certain embodiments, the controller 104 may instruct the downforce actuator 114 to increase or decrease the downforce such that the determined downforce is within a threshold range of the target downforce. As a result, undesirable soil compaction from the gauge wheel may be reduced and/or the penetration depth of the opener disc may be substantially maintained. Furthermore, it may be appreciated that by controlling the downforce on the gauge wheel via the downforce actuator 114 may allow the opener disc to penetrate the ground at a suitable depth, thereby ensuring a suitable seed placement depth that results in higher yields.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A downforce monitoring system for an agricultural row unit, comprising:
a controller comprising a processor and a memory, wherein the controller is configured to:
receive one or more signals from one or more sensors, wherein each of the one or more signals is indicative of a downforce applied to a soil surface by a gauge wheel of the agricultural row unit; and
determine a determined downforce applied to the soil surface by the gauge wheel based on the one or more signals;
wherein the one or more sensors are engaged with a pin, and the pin is configured to rotatably couple a depth adjustment arm to a shaft of the row unit.

2. The downforce monitoring system of claim 1, comprising the one or more sensors, wherein the one or more sensors are communicatively coupled to the controller, and the one or more sensors are configured to output the one or more signals to the controller.

3. The downforce monitoring system of claim 1, wherein the one or more sensors are at least partially coupled to:
a first inner surface of a first hole formed into the shaft;
a second inner surface of a second hole formed into the depth adjustment arm; or
a combination thereof.

4. The downforce monitoring system of claim 3, wherein the first hole and the second hole are configured to concurrently receive the pin.

5. The downforce monitoring system of claim 3, wherein the depth adjustment arm comprises a first arm and a second arm, and the shaft comprises an axial end portion disposed between the first and second arms.

6. The downforce monitoring system of claim 5, wherein an outer circumferential perimeter of the axial end portion of the shaft comprises one or more flat sides.

7. The downforce monitoring system of claim 5, wherein an outer circumferential perimeter of the axial end portion of the shaft is rounded.

8. The downforce monitoring system of claim 1, wherein the one or more sensors comprise:
a force sensor;
a strain gauge; or
a combination thereof.

9. The downforce monitoring system of claim 8, wherein the controller is configured to:
receive a first signal from the force sensor indicative of a force exerted by the shaft onto the pin;
receive a second signal from the strain gauge indicative of a bending load exerted onto the pin by the shaft and the depth adjustment arm; or
a combination thereof.

10. A system, comprising:
an agricultural row unit, comprising:
a frame;
a gauge wheel;
an opener disc;
a shaft configured to rotatably couple the opener disc to the frame;
a depth adjustment arm configured to adjust a position of the gauge wheel relative to the opener disc; and
a pin configured to rotatably couple the depth adjustment arm to the shaft; and
a controller comprising a memory and a processor, wherein the controller is configured to:
receive one or more signals from one or more sensors, wherein each of the one or more signals is indicative of a downforce applied to a soil surface by the gauge wheel; and
determine the downforce applied to the soil surface by the gauge wheel based on the one or more signals;
wherein the one or more sensors are configured to engage with the pin.

11. The system of claim 10, comprising the one or more sensors, wherein the one or more sensors are communicatively coupled to the controller, and the one or more sensors are configured to output the one or more signals to the controller.

12. The system of claim 10, wherein the one or more sensors are at least partially coupled to:
a first inner surface of a first hole formed into the shaft;
a second inner surface of a second hole formed into the depth adjustment arm; or
a combination thereof.

13. The system of claim 12, wherein at least one of the one or more sensors is disposed across an interface between the first inner surface and the second inner surface.

14. The system of claim 12, wherein the first hole and the second hole are configured to concurrently receive the pin.

15. The system of claim 12, wherein the depth adjustment arm comprises a first arm and a second arm, and the shaft comprises an axial end portion disposed between the first and second arms.

16. The system of claim 15, wherein an outer circumferential perimeter of the axial end portion of the shaft comprises one or more flat sides.

17. The system of claim 15, wherein an outer circumferential perimeter of the axial end portion of the shaft is rounded.

18. The system of claim 10, wherein the one or more sensors comprise:
a force sensor;
a strain gauge; or
a combination thereof.

19. One or more tangible, non-transitory, machine-readable media comprising instructions configured to cause a processor of a controller to:
receive one or more signals from one or more sensors, wherein each of the one or more signals is indicative of a downforce applied to a soil surface by a gauge wheel of a row unit; and
determine the downforce applied to the soil surface by the gauge wheel based on the one or more signals;
wherein the one or more sensors are engaged with a pin configured to rotatably couple a depth adjustment arm to a shaft of the row unit.

20. The one or more tangible, non-transitory, machine-readable media of claim 19, wherein the one or more sensors comprise:
a force sensor;
a strain gauge; or
a combination thereof.
